(19) United States
(12) Patent Application Publication
(10) Pub. No.: US 2013/0029236 A1
(43) Pub. Date: Jan. 31, 2013

(54) Device for Providing Hot Exhaust Gases

(71) Applicants: Holger Stark, Allmersbach im Tal (DE); Ulf-Michael Mex, Stuttgart (DE); Gerhard Konrad, Ulm (DE); Benjamin Steinhauser, Bad Wurzach-Arnach (DE); Gert Hinsenkamp, Esslingen (DE)

(72) Inventors: Holger Stark, Allmersbach im Tal (DE); Ulf-Michael Mex, Stuttgart (DE); Gerhard Konrad, Ulm (DE); Benjamin Steinhauser, Bad Wurzach-Arnach (DE); Gert Hinsenkamp, Esslingen (DE)

(73) Assignee: Daimler AG, Stuttgart (DE)

(21) Appl. No.: 13/582,690

(22) PCT Filed: Dec. 4, 2010
(86) PCT No.: PCT/EP2010/007379

§ 371 Date: Oct. 9, 2012

(30) Foreign Application Priority Data
Mar. 5, 2010 (DE) 10 2010 010 272.5

(51) Int. Cl. F23R 3/40; H01M 8/06; F02C 7/266

(52) U.S. Cl. 429/415; 60/723; 60/39.827

(57) ABSTRACT

A device used to provide hot exhaust gases for driving a turbine. The device includes a burner, the combustion zone of which is directly mounted on or integrated into the gas inlet (turbine housing) of the turbine. The burner is supplied with at least one combustible gas or gas mixture. The combustion zone includes a porous material with a large specific surface area.

### BACKGROUND AND SUMMARY OF THE INVENTION

Exemplary embodiments of the present invention relate to a device for the provision of hot exhaust gases for driving a turbine and to the use of a device of this type.

The principle of operating turbines with hot exhaust gases from a combustion process is known. U.S. Patent Application Publication No. 2002/0157881 A1, for example, describes an assembly in which electric energy is provided for a vehicle by means of a turbine driven via a burner and by means of a generator. The special feature of this arrangement is that the burner is integrated into the turbine or the turbine intake housing. The burner itself is designed as a flame burner that provides as high a temperature as possible for the operation of the turbine. This design has the disadvantage that such a burner, owing to the very high temperatures and the difficulties involved in controlling combustion, causes the emission of a lot of undesirable materials, for example NOₓ emissions. For this reason, an optional catalytic reactor is provided, which, in the manner of a catalytic converter sited downstream of an internal combustion engine, converts residues in the turbine following the expansion of the hot exhaust gas of the combustion process. This causes the generation of a certain degree of residual heat in the exhaust gas, which has to be recovered by means of a heat exchanger in a comparably complex and expensive manner. In addition, the assembly, which is compact with regard to the burner, becomes larger by adding the catalytic converter.

From the preferred application of the present invention, the use of burners in combination with turbines in fuel cell systems is known as well.

For example, German Patent Document DE 103 06 234 A1 describes a device for supplying a fuel cell with air. This device is designed as a turbocharger with electric support. In the region of the expander or the turbine respectively, hot gases are expanded in order to provide at least a part of the energy required for the air supply. A burner designed as a pore burner or a catalytic burner is provided to generate the hot gases. This combusts the exhaust gases of the fuel cell and can, if required, additionally be supplied with the fuel of the fuel cell. A comparable design is known from the Japanese Abstract JP 59075571 A.

Although these designs are capable of providing hot gases in the fuel cell system, there is frequently no guarantee that all of the undesirable residues present in the exhaust gas of the fuel cell, such as hydrocarbons when using a gas generation system as described in the JP abstract or hydrogen residue when using a hydrogen reservoir as described in the DE specification, are completely converted. This is typically due to the fact that a secure and reliable initiation of the catalytic reaction in the burner can often only be achieved with major difficulties and is not sufficiently repeatable.

Exemplary embodiments of the present invention are directed to a device for the provision of hot exhaust gases for driving a turbine, which device optimally utilizes the chemical energy present in the combustible gases used for driving the turbine and, without any further measures, makes available an exhaust gas that does not contain any harmful emissions.

In accordance with exemplary embodiments of the present invention the burner, which is directly connected to the turbine or partially or wholly integrated into the turbine housing, comprises a combustion zone having a porous material with a large specific surface area. This design as a pore burner, matrix burner or matrix radiation burner allows for a very even and efficient combustion without using an open flame. In this way, a very compact design can be implemented which, using a minimum of space, is directly connected to the turbine, or integrated into the turbine, for example into the turbine housing, or installed into the turbine housing in the form of a cartridge. Owing to the positive characteristics of a matrix burner or pore burner, and owing to the thermal energy radiated by the burner, nearly all of the components of the gas stream to be combusted can be combusted very efficiently. The design is further extraordinarily compact and efficient.

In a particularly expedient embodiment of the device according to the invention, the porous material with a large specific surface area comprises at least one catalytically active material. In this case, the burner is not only just a pore burner, a matrix burner or the like, but also a catalytic burner that safely and reliably converts materials present in the exhaust without an open flame.

In a very advantageous and expedient further development of the device according to the invention, the burner can be intermittently supplied with fresh air, the burner comprising an ignition device by which a combustion of at least the fresh air and the fuel of the fuel cell can be initiated. The burner is therefore supplied, in addition to the exhaust gas of the fuel cell and the at least intermittent supply of fuel, with fresh air. This fresh air, which is preferably supplied together with the fuel, then makes it possible to initiate a combustion of the air and the fuel via an ignition device installed into the burner. Due to this ignition, which for example happens upstream of the combustion zone proper in the direction of flow, e.g. upstream of the porous structure of a pore burner, the burner can always be started safely and reliably by means of the upstream ignition device. This ensures that the desired hot exhaust gases, which can for example be used for driving a turbine, are always available when required. Furthermore, the fuel and the exhaust gas from the fuel cell can always be fully converted in the region of the burner, so that there is no emission of hydrogen, hydrocarbons, carbon monoxide, nitrogen oxides (NOₓ) or the like into the environment of the fuel cell.

In a very advantageous and expedient further development, fresh air and fuel can be merged with the exhaust gases from the fuel cell downstream of the ignition device and upstream of the combustion zone in the direction of flow. This design allows for a highly controllable and reliable ignition of the fuel together with the added fresh air, while the exhaust gases are only merged with this already burning mixture after ignition, before or when the combustion zone is reached. This offers the advantage that, irrespective of the composition of the exhaust gases, an ignitable mixture can always be obtained, because in the region of the ignition device only the fuel and the fresh air are present, the mixing ratio of which can be controlled easily without having to determine, for example, the residual fuel content and the residual oxygen content of the exhaust gases using expensive and complex sensor systems.

In an alternative embodiment of the present invention, the fresh air and the fuel of the fuel cell can be directed into the region of the ignition device in such a way that an ignitable mixture is present locally. Instead of the merging of the gas streams only after ignition by using a suitable separating device or separate line elements, in the alternative embodiment an ignitable mixture is locally present at the ignition device as a result of a directed supply of the fresh air and the fuel into the region of the ignition device. The fresh air and the fuel may, for example, be supplied via nozzle-type elements or a directed inflow under increased pressure in such a way that they flow into the region of the ignition device in such a way that there is at this point a higher concentration of fresh air and fuel than in the surrounding regions, in which there are more exhaust gases from the fuel cell.

The ignition device may in principle be designed in various ways. Conceivable examples are ignition devices in form of glowing elements, such as a ceramic incandescent igniter or an incandescent coil. Particularly efficient, however, is an ignition device that ignites the mixture using sparks. By means of a spark, an ignition of the ignitable mixture of air and fuel is obtained safely and reliably using comparably little energy, and an ignition device operating with sparks provides very fast ignition without any need for preheating or similar processes.

In a particularly expedient and advantageous application, the device according to the invention is used to drive a turbine in a fuel cell system, the burner being supplied at least with the exhaust gases from a fuel cell of the fuel cell system.

As is known from prior art described above, burners and turbines are used in fuel cell systems in order to recover residual energy from the exhaust gases of a fuel cell system. This residual energy is then converted in the form of pressure and heat in a turbine. The turbine may, for example, drive a compressor and/or an electric generator for the provision of electric energy. This energy recovery from the fuel cell system offers the additional advantage that the residues in the exhaust gases of the fuel cell are fully converted, so that there are no hydrocarbon or hydrogen emissions into the environment. The burner is ideally designed as a catalytic burner, so that even NOₓ emissions can be prevented owing to flameless combustion at a relatively low temperature of approximately 600° C.

Further advantageous variants of the device according to the invention will become clear from the embodiment which is described in greater detail below with reference to the figures.

### BRIEF DESCRIPTION OF THE DRAWING FIGURES

Of the figures:

FIG. 1 shows a first possible embodiment of a fuel cell system provided with a device according to the invention.

FIG. 2 shows a further possible embodiment of a fuel cell system provided with a device according to the invention.

FIG. 3 shows a first possible embodiment of the burner according to the invention.

FIG. 4 shows a further embodiment of the burner according to the invention; and

FIG. 5 shows a further alternative embodiment of the burner according to the invention.

### DETAILED DESCRIPTION

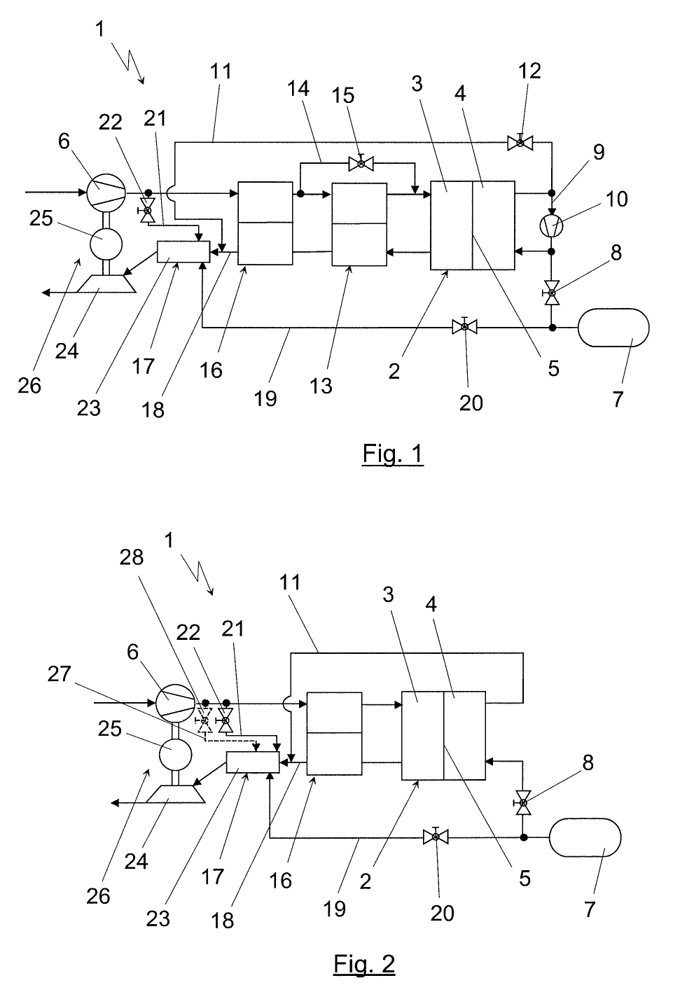

FIGS. 1 and 2 show two different designs of fuel cell systems 1, which are the preferred, but not the sole, application for the device according to the invention for the provision of hot exhaust gases. The core of the fuel cell system 1 is a fuel cell 2, which may for example be a stack of PEM fuel cells. A cathode compartment 3 and an anode compartment 4 of the fuel cell 2 are separated from each other by proton-conducting membranes 5. The oxidant for the operation of the fuel cell 2 is typically the oxygen in the air, air being piped into the cathode compartment 3 via an air conveying device 6. The anode compartment 4 is supplied with hydrogen or with a gas containing hydrogen. In the illustrated embodiment, hydrogen is to be supplied to the anode compartment 4 of the fuel cell 2 from a compressed gas reservoir 7. The hydrogen stored under high pressure in this compressed gas reservoir 7 is fed into the anode compartment 4 via a valve device 8 and in this process expanded to a pressure level suitable for the operation of the fuel cell 2. If pure hydrogen is used as a fuel fur the fuel cell 2, this is typically made available to the anode compartment 4 at a higher flow rate than can be converted in the anode compartment 4 of the fuel cell 2. The purpose of this arrangement is as even a supply of sufficient amounts of hydrogen as possible to the entire available active surface of the proton-conducting membrane 5. The unused hydrogen is discharged from the anode compartment 4 via a recirculation line 9 and re-supplied to the anode region 4 by means of a recirculation device 10, such as a hydrogen recirculation fan and/or a gas jet pump or the like, together with fresh hydrogen from the compressed gas reservoir. In the course of time, nitrogen which has entered the anode compartment 4 through the membrane 5 accumulates in the region of the recirculation line 9, as well as a small amount of product water which is generated in the anode compartment 4 of the fuel cell 2. As these inert materials cannot be converted in the fuel cell, they lower the hydrogen concentration in the volume of the recirculation line 9 and the anode compartment 4 in the course of time. For this reason, the materials present in the region of the recirculation line 9 are from time to time discharged via a discharge line 11 and a valve device 12 provided therein, in order to maintain the hydrogen concentration in the anode compartment 4. As some residual hydrogen escapes from the system while these materials are discharged via the discharge line 11—the so-called purge line—the discharged material stream has to be post-treated in the manner to be described later, in order to prevent any emissions into the environment.

The membranes 5 of the fuel cell 2 are relatively sensitive to drying out. As the air flow conveyed by the air conveying device 6 is typically dry, a high flow rate can accelerate the drying-out of the membranes 5. For this reason, the fuel cell system 1 can be provided with a humidifier 13, which may be designed, for example, as a gas-gas humidifier. Membranes permeably to water vapor form the core of such a humidifier 13. On one side of the membranes, the dry gas stream conveyed by the air conveying device 6 flows. On the other side of the membranes, the exhaust gas stream flows from the cathode compartment 3 of the fuel cell 2. As the major part of the product water is generated in the cathode compartment 3 of the fuel cell 2, this exhaust gas flow is loaded with liquid in the form of water vapor and droplets. The water vapor can humidify the dry air in the humidifier 13 through the membranes, so that the outgoing air can be dehumidified and a humidification of the membranes 5 of the fuel cell 2 by the humidified supply air can be ensured. As full humidification is not desirable in all situations, a bypass 14 can be provided to bypass the humidifier 13; in the illustrated embodiment, this is situated in the region of the supply air line to the cathode compartment 3, but in principle it can also be situated in the region of the discharge air line from the cathode compartment 3. Via a valve device 15, this bypass 14 can be controlled in such a way that the flow through the humidifier 13 is suitably divided. In this way, humidity can be adjusted in the region of the cathode compartment 3.

The design of the fuel cell system 1 as shown in FIG. 1 further comprises an intercooler 16, through which flow the supply air downstream of the air conveying device 6 and the discharge air from the cathode compartment 3. Downstream of the air conveying device 6, the air will be correspondingly hot, because it is heated in the compression process. The discharge air from the cathode compartment 3, on the other hand, is cooler. The intercooler 16 provides for an exchange of heat between the two gas streams, so that the air conveyed to the cathode compartment 3 is cooled and the air discharged from the cathode compartment 3 is heated. This cooling of the air downstream of the air conveying device 6 further reduces the risk of the drying-out of the membranes 5 of the fuel cell. The heat introduced in the intercooler 16 into the discharge air from the cathode compartment 3 can now be used to advantage as described later.

The heated discharge air flows from the intercooler 16 via a discharge air line 18 into a burner 17, in which it can be converted together with residual hydrogen from the discharge line 11 and, if required, together with hydrogen supplied from the compressed gas reservoir 7 via a hydrogen line 19 and a valve device 20. In addition, the burner 17 is supplied with fresh air via a fresh air line 21 with a valve device 22, this fresh air being taken from the supply air flow to the cathode region downstream of the air conveying device 6. These materials are now converted in a combustion process in a combustion zone 23 of the burner 17. The combustion zone 23 can in particular be provided with a porous material with a large specific surface area. The burner 17 may therefore be designed, for example, as a pore burner or a matrix burner.

In the embodiment of the fuel cell system 1 shown in FIG. 1 the hot exhaust gases generated from the source materials described above then enter the region of a turbine 24 and are expanded and cooled in the region of the turbine 24. In this way, mechanical energy can be recovered from the hot exhaust gas stream of the fuel cell system by means of the turbine 24. In the illustrated embodiment, the turbine 24 can directly supply the air conveying device 6 with mechanical energy. In addition, an electric machine 25 may be provided that can be operated as a generator if enough surplus energy is available in the region of the turbine 24, in order to recover electric energy from the hot exhaust gas stream. If the air conveying device requires more energy than the turbine 24 can provide, the electric machine 25 can be operated as a motor. In this case, it would provide the required energy differential for conveying the air via the air conveying device 6. This assembly of a turbine 24, an electric machine 25 and an air conveying device 6—the latter being typically designed as a turbo-compressor—is generally known as an electric turbocharger (ETC) 26.

Apart from such an ETC 26, the hot exhaust gases could of course be used in other applications, for example in a system for generating a hydrogen-containing gas from a hydrocarbon-containing source material by means of vapor reforming, auto-thermal reforming or the like. In addition, it would of course be possible to integrate the turbine 24 not into an ETC, but into a free-running turbocharger with the turbine 24 on one side and only the air conveying device 6 as a turbo-compressor on the other side. The turbo-compressor of the free-running turbocharger could for example form a stage of the air conveying device 6. Furthermore, the turbo-compressor could obviously be driven by any other conceivable means, and the turbine 24 could just be coupled to an electric machine 25 or a generator 25. In this case, electric energy can be provided via the turbine 24. It would also be possible to use the mechanical energy generated by the turbine 24 via a suitable gear unit mechanically for driving auxiliaries and/or for supporting the drive of a vehicle.

In the burner 17, all of the exhaust gas from the region of the fuel cell 2 is utilized. By means of the optional hydrogen supply via the hydrogen line 19 and the valve device 20, the turbine can be heated in a controlled manner. In such cases, a boost operation of the fuel cell system 1 could for example be implemented, in which a comparably high energy can temporarily be made available via the turbine 24 by introducing hydrogen into the burner 17. This could then be converted into electric power for use in a vehicle system via the electric machine 25 operated as generator, in order to satisfy dynamic power demands which the fuel cell 2 cannot cover adequately. This allows for boost operation, for example, or in an emergency even for operation with the fuel cell 2 switched off.

FIG. 2 shows a comparable system design which could be used as an alternative to the fuel cell system 1 described above. The essential difference of this design lies in the fact that there is no recirculation line 9 about the anode compartment 4 of the fuel cell 2. In this design, the anode compartment 4 is only supplied with a small amount of excess hydrogen, which is directly fed to the burner 17 through the discharge line 11, which in this case does not comprise a valve, and converted therein together with the discharge air from the cathode compartment 3. Here, too, there is a continuous conversion of the two exhaust gas streams from the fuel cell 2, and additional air and/or additional hydrogen can be supplied via the hydrogen line 19 or the fresh air line 21. In this design, the humidifier 13, the bypass line 14 and the valve device 15 were omitted as well. Depending on the type of the membranes 5 used, operation without humidification is now conceivable even in PEM fuel cells. In principle, designs without an intercooler 16 are possible as well. In the design described here, however, this offers the advantage that the discharge air from the cathode compartment 3 of the fuel cell 2 is heated, providing an already warm exhaust gas stream for the burner 17. Moreover, a suitably cooled flow of supply air to the cathode compartment 3 of the fuel cell 2 conserves the membranes 5, which is beneficial to the service life of the membranes 5, in particular when operating without a humidifier 13. In this way, energy utilization and the exhaust gas temperature of the burner 17 can be increased, so that the intercooler 16 also offers advantages with respect to the service life of the membranes 5 and to the utilization of the energy used.

FIG. 2 further shows, in addition to the fresh air line 21 with its valve device 22, an optional cool air line 27 with a valve device 28. The function of this will be described in greater detail later. In the embodiment of the fuel cell system 1 as shown in FIG. 2, an electric turbocharger 26 is also provided; the above explanations apply to this electric turbocharger 26 as well, and it should be understood by way of example only.

The essential aspect of the fuel cell systems described with reference to FIGS. 1 and 2 is the design of the burner 17. FIG. 3 shows a first possible embodiment of the burner 17 for the provision of hot exhaust gas. In the simplest embodiment shown in FIG. 3, the burner is designed such that it consists virtually entirely of the combustion zone 23. This combustion zone 23 in turn consists of a porous material having a large specific surface area. The material may be, for example, a knitted fabric of undirected fibers, a collection of unidirectional fibers, an open-cell foam or a porous sintered material, for example a metal- or ceramic-based material. As will be described with reference to another embodiment later, the combustion zone 23 could conceivably consist of a mesh or fabric of metallic or ceramic material and be designed as a so-called matrix burner or matrix radiation burner.

The burner 17 shown in FIG. 3 is a catalytic burner. The material of the combustion zone 23 therefore comprises a catalytically active material which is, for example, finely distributed within the porous structure or covers at least parts of the surface of the porous structure in the form of a coating. Suitable catalytic materials include, for example, palladium, platinum or the like. Owing to the design of the catalytic burner 17, the exhaust gases of the fuel cell 2 flowing to the burner 17, which are here indicated as a gas mixture by an arrow and which originate or can originate from the discharge line 11, the discharge air line 18, the hydrogen line 19 and the fresh air line 21, are directed into the region of the combustion zone 23. There, a catalytic reaction or a catalytic combustion takes place, so that the materials present in the exhaust gases of the fuel cell 2 and, if applicable, in the additional hydrogen supplied from the hydrogen line 19 are converted without the formation of a flame. In addition to the provision of hot exhaust gases at a temperature level of 600° C. for driving the turbine 24, this catalytic combustion ensures an almost complete conversion of the combustible materials in the gas stream flowing to the burner 17, so that emissions are largely avoided.

FIG. 3 further shows that the combustion zone 23 is integrated into the inlet region of a helical turbine housing 29 of the turbine 24. With this design the turbine 24 and the burner 24 require a minimum of space. In addition, the length of the path along which the flow of hot exhaust gases has to be routed from the burner 17 to the turbine 24 is minimized. As a result, heat losses are avoided and there is very little need for expensive high temperature resistant materials for the length of the line. Only the turbine housing has to be made of a suitable high temperature resistant material or at least coated with such a material, for example a material based on ceramics, in the region of its interior walls. The design shown in FIG. 3 with a burner 17 directly mounted on the turbine 24 or integrated into the turbine housing 29 of the turbine 24, quite apart from requiring a minimum of space, allows for a highly efficient operation with an optimum utilization of the hot exhaust gases. Owing to the catalytic coating of the porous material with its large specific surface area in the region of the combustion zone 23, all of the combustible residues present in the exhaust gas of the fuel cell 2 can be converted completely, so that harmful emissions into the environment of the fuel cell system 1 are avoided.

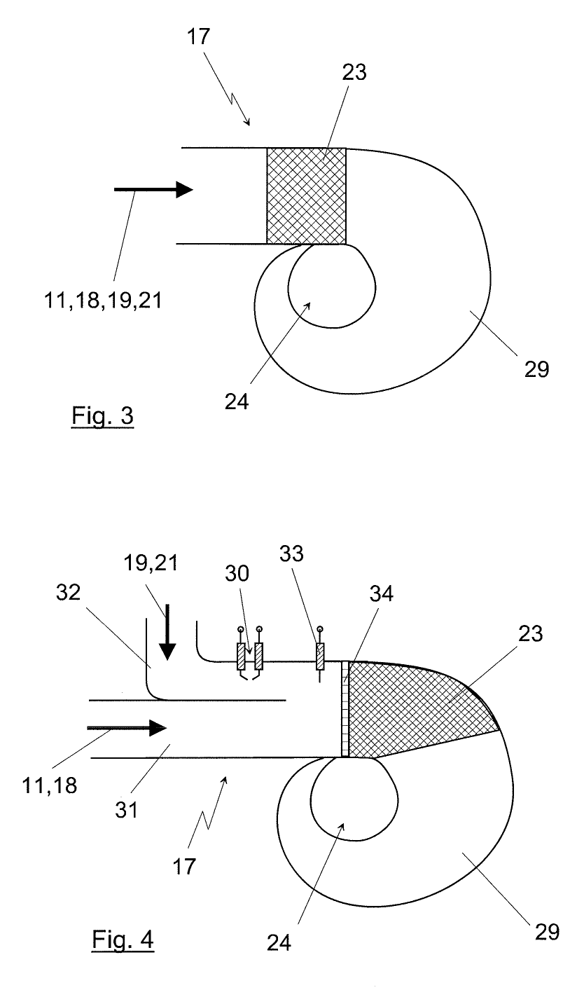

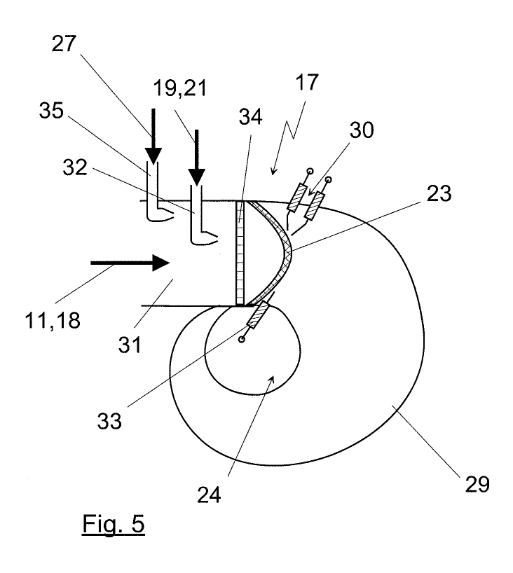

A potential problem of catalytic burners 17 may lie in the fact that ignition may be difficult in certain operating situations or the burners may reach their so-called light-off temperature with some delay, so that non-combusted materials can pass through the combustion zone 23. This results in emissions and materials that otherwise could be converted into useful thermal energy flow out of the fuel cell system 1 without being utilized. To avoid this, the burner 17 in the turbine housing 29 may comprise an ignition device 30 as shown in FIG. 4. The design of the burner 17 shown in FIG. 4 also includes a combustion zone 23 with a porous material. In addition, the exhaust gas from the fuel cell 2, in particular from the discharge line 11 and the discharge air line 18, is supplied via a line element 31. Via a further line element 32, hydrogen from the hydrogen line 19 and fresh air from the fresh air line 21 are fed in. The ignition device 30 is located in the region of the line element 32, so that there is always an easily ignitable mixture of hydrogen and fresh air available in this region. In order to check for reliable ignition in the region of the ignition device 30, the burner 17 may further be provided with a monitoring electrode 33 for verifying that an ignition has been achieved.

Apart from that, the structure of the burner 17 shown in FIG. 4 resembles that of the burner described with reference to FIG. 3. The combustion zone, which likewise includes a porous material in the manner of a pore burner, is integrated more fully into the turbine housing 29 than shown in FIG. 3, resulting in a very compact design in which the hot exhaust gases only have to cover a very short distance from the region of the burner 17. Here, too, the combustion zone 23 is in particular provided with a catalytically active material, so that the burner 17 is a catalytic burner. However, a comparable design would be conceivable in a burner 17 without any catalytic coating.

In the illustration of FIG. 4, a flame trap 34 is further provided upstream of the combustion zone 23 in the direction of flow of the gases towards their conversion or combustion. Such a flame trap is known from general prior art and commonly used in various types of burners. It typically consists of a perforated sheet or a similar material and prevents flashback from the region of the burner into the region of the inflowing gases.

In a variant of the burner not shown in the drawing, as an alternative to the two line elements 31, 32, the respective gas streams, in particular the fresh air from the fresh air line 21 and the hydrogen from the hydrogen line 19, are directed into the region of the ignition device 30 via nozzle elements or similar devices in such a way that an ignitable mixture is made available there irrespective of the exhaust gases of the fuel cell 2, which are already merging with the fresh air and the hydrogen. This variant would omit the two separate line elements 31, 32 and could perhaps be made even more compact.

FIG. 5 shows a further possible embodiment of the burner 17. Here, too, the burner 17 is largely integrated into the turbine housing 29 of the turbine 24. The combustion zone 23 is designed as a combustion zone of a matrix burner or a matrix radiation burner. This means that the combustion zone 23 is a typically domed element made of a woven or mesh fabric, typically based on a metallic or ceramic material. The combustion zone 23 may be, for example, a part of a spherical cap, a cylinder or a cone. The material of the matrix, which here represents the combustion zone 23, may also include a catalytic material, for example by giving a catalytic coating to some or all of the fibers used to form the woven fabric or mesh. As usual in the case of matrix burners, the combustion is started via the ignition device 30 on the side of the combustion zone 23 which is remote from the incoming gases, as shown in the figure. The monitoring electrode 33 described above can obviously be provided in this case as well in order to check for safe and reliable ignition. Another option is a flame trap 34 in the region between the combustion zone 23 and the incoming gases.

The burner 17 as shown in FIG. 5 is designed such that the discharge air from the discharge air line 18 approaches via a line element 31 from the cathode compartment 3 of the fuel cell 2 together with the residual hydrogen from the discharge line 11. Via a further line element 32, which here projects from above into the region of the line element 31, hydrogen is fed in from the hydrogen line 19 and fresh air is fed in from the fresh air line 21. The end of the line element 32 is designed in the manner of a nozzle, so that the fresh air and the hydrogen are routed into the region of the ignition device 30 relatively directly, in order to provide there a safe and reliable initiation of combustion at the matrix burner forming the combustion zone 23, which may have a catalytic coating. In addition to this design, which is comparable to that described with reference to the preceding figures, the design of the burner 17 according to FIG. 5 includes a third line element 35 via which cooling air can be supplied from the region of the cooling air line 27 described with reference to FIG. 2. In certain operating situations, this cooling air can result in a reduction of the temperature of combustion by providing a suitable volume of excess air, so that the permitted operating temperatures of the turbine 24 and/or the combustion zone 23 are not exceeded. In this way, damage to, for example, the catalytic coating of the combustion zone 23 by overheating can be prevented while the complete combustion of the source materials continues to be ensured.

As a whole, the burner 17 is extraordinarily compact and can either be directly integrated into the turbine housing 29 or adjoin the latter directly. It is further conceivable to design the burner 17 as an independent cartridge which is only inserted into the intake region of the turbine housing 29 in the assembly process.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A device for the provision of hot exhaust gases for driving a turbine, comprising:
a burner having a combustion zone directly mounted on or integrated into a gas inlet of the turbine, the burner is configured to be supplied with at least one combustible gas or gas mixture, wherein the combustion zone comprises a porous material with a large specific surface area.

12. The device according to claim 11, wherein the porous material with a large specific surface area includes at least one catalytically active material.

13. The device according to claim 12, wherein the catalytically active material comprises palladium.

14. The device according to claim 11, wherein the burner configured to at least be intermittently supplied with fresh air, the burner comprising an ignition device by means of which a combustion of at least the fresh air and fuel of fuel cell can be initiated.

15. The device according to claim 14, wherein the fresh air and the fuel of the fuel cell are merged with the exhaust gases from the fuel cell downstream of the ignition device and upstream of the combustion zone in the direction of flow.

16. The device according to claim 14, wherein the fresh air and the fuel of the fuel cell are routed into the region of the ignition device in such a way that an ignitable mixture of the two materials is available locally.

17. The device according to claim 14, wherein the ignition device is configured to ignite the mixture of gasses using sparks.

18. A fuel cell system, comprising:
a turbine;
a fuel cell; and
a burner having a combustion zone directly mounted on or integrated into a gas inlet of the turbine, the burner is configured to be supplied with at least one combustible gas or gas mixture from the fuel cell, wherein the combustion zone comprises a porous material with a large specific surface area.

19. The fuel cell system according to claim 18, wherein the burner is configured to also be supplied with air, and supplied with fuel of the fuel cell.

20. The fuel cell system according to claim 19, wherein the turbine is coupled to a compressor for a process air flow to the fuel cell or to an electric machine.
